(19) United States
(12) Patent Application Publication
(10) Pub. No.: US 2003/0051019 A1
(43) Pub. Date: Mar. 13, 2003

(54) Repository system and method for controlling an embedded device

(76) Inventor: Tom Oswald, Tigard, OR (US)

Correspondence Address: David C. Ripma, Patent Counsel, Sharp Laboratories of America, Inc., 5750 NW Pacific Rim Boulevard, Camas, WA, 98607, US

(21) Appl. No.: 09/949,366

(22) Filed: Sep. 7, 2001

(51) Int. Cl. G06F 15/173

(52) U.S. Cl. 709/223

(57) ABSTRACT

A system and method are provided for controlling an embedded device. The method comprises: establishing a control code repository; establishing a plurality of objects corresponding to a plurality of control routines; establishing a range of selectable data values associated with each data object; accessing the repository through a plurality of mediums selected from the group including an embedded device front panel, simple network management protocol (SNMP), hypertext transport protocol (HTTP), a serial port, and a parallel port; and, using the control codes to communicate with an embedded device as follows: selecting data values; and, issuing commands to the embedded device in response to the data values.

### BACKGROUND OF THE INVENTION

1. Field of the Invention

This invention generally relates to devices with embedded microprocessors and, more particularly, to a system and method for controlling embedded microprocessor devices with a central control code repository.

2. Description of the Related Art

Embedded devices, including multifunction peripherals (MFPs), may be controlled remotely over a network via protocols such as simple network management protocol (SNMP) and hypertext transport protocol (HTTP), or manually from the MFP's front panel. As used herein, an embedded device is considered to be a device with a microprocessor. Typically, the microprocessor is used for control of the device functions. These embedded microprocessors have an interface to receive instructions for manipulating and configuring the device functions.

The combination of these means of controlling the printer (MFP), or interfacing with the embedded microprocessor is referred to as a control mechanism. Access to the control mechanism requires a medium. For example, SNMP requires access to a network, hence SNMP's “medium” is the protocol stacks which give access to the network. The code that these control mechanisms execute to control or modify the functions of the MFP is typically referred to as control code, which is embedded in the MFP or device to be controlled. There are problems associated with the conventional ways of controlling an embedded device.

FIG. 1 is a schematic block diagram illustrating a conventional embedded device control system (prior art). The control code is part of the embedded device and, therefore, tied to the medium. Since there are three different mediums, three versions of the code are required. Because the control code is embedded in the MFP or device to be controlled, it is consequently duplicated for each medium, increasing the overall size of the code. For example, many MFPs are shipped with front panel, HTTP, and SMNP codes, thus duplicating the control code necessary to control the MFP.

Since the control code is embedded in the MFP or embedded device, control of the embedded device is lost when the mechanism (control code) is removed from the code base of the printer. For example, SNMP control of an MFP requires the SNMP agent to be embedded in the MFP prior to shipping. If the SNMP agent is removed, the MFP will no longer respond to an SNMP protocol once the MFP is brought on-line by a customer who utilizes SNMP as a means of remotely controlling their printer.

The control code is not only tied to the device to be controlled, it is also tied to the medium. For example, if SNMP is directed to disable the MFP's network access, control of the MFP through SNMP is completely lost, as the only way of directing SNMP to enable the network access is through the network access itself.

Conventional attempts to solve the above-mentioned problems include the following: (a) only allowing control of the embedded device through a single medium; (b) allowing SNMP to be driven as a back end to HTML by manipulating certain settings on the HTML page that are linked to SNMP leaf nodes; or, (c) removing the control code from the device to be controlled resulting in many different subroutine interfaces.

Attempts to solve the above-mentioned problems have met with limited success. The first above-mentioned solution is simple, but leaves the user with limited control options. The second solution permits SNMP to be driven as a back end to HTML, by manipulating certain settings on the HTML page that are linked to SNMP leaf nodes. Setting certain entities on a HTML page that are linked to SNMP leaf nodes causes the code to make SNMP calls in order to affect the system. This eliminates the duplication of the control code while allowing two control mechanisms to control the device, i.e., SNMP and HTTP. However, this solution still necessitates the presence of a SNMP agent and therefore leaves the control code as part of SNMP.

FIG. 2 is a schematic block diagram illustrating another conventional embedded device control system (prior art). The control code is extracted from the embedded device, resulting in many different interfaces which need to be called in order to control the embedded device. For example, the control code can be removed from SNMP so it can be called by HTML and other mechanisms. That is, the code controlling the embedded device is no longer part of the SNMP, or any other medium. The code is then a set of independent subroutines, each requiring a unique set of parameters and return status. The problem is that the numerous subroutines throughout the system make it difficult for developers. Developers may not know that certain control code even exists, and may write code that duplicates existing functionality. Even if all of the control code is kept in one place, it still presents the problem of having a different interface for every control code subroutine.

It would be advantageous if embedded devices could be more easily controlled.

It would be advantageous if the control code for an embedded device could be simplified.

It would be advantageous if embedded devices could be configured and operation with a single control code protocol, regardless of the mediums used to communicate with the embedded device.

### SUMMARY OF THE INVENTION

The present invention solves the aforementioned problems by removing the control code from the embedded device and places the control code in a control code repository. Each data value in the repository has a unique control routine tied to a data entity. Therefore, each time a data entity is changed, the new value causes the control code to affect the embedded device. For example, if embedded device network access is controlled through a first data entity in the repository, the control code will enable/disable the network access depending on the specific value of the data entity. The data values are set through a single calling interface. Therefore, the control of the embedded device is centralized and accessible through one subroutine interface to the data repository, and it is accessible across every medium.

Accordingly, a method is provided for controlling an embedded device. The method comprises: establishing a control code repository; establishing a plurality of objects corresponding to a plurality of control routines; establishing a range of selectable data values associated with each data object; accessing the repository through a plurality of mediums selected from the group including an embedded device front panel, simple network management protocol (SNMP), hypertext transport protocol (HTTP), a serial port, and a parallel port; and, using the control codes to communicate with an embedded device as follows: selecting data values; and, issuing commands to the embedded device in response to the data values.

Additional details of the above-described method, and a system for controlling an embedded device are presented below.

### BRIEF DESCRIPTION OF THE DRAWINGS

FIG. 1 is a schematic block diagram illustrating a conventional embedded device control system (prior art).

FIG. 2 is a schematic block diagram illustrating another conventional embedded device control system (prior art).

FIG. 3 is a schematic block diagram illustrating the present invention system for controlling an embedded device.

FIG. 4 is a schematic block diagram illustrating the repository of FIG. 3 in greater detail.

FIG. 5 is an exemplary communication pattern such as might occur between the repository and a medium.

FIGS. 6a and 6b are flowcharts illustrating the present invention method for controlling an embedded device.

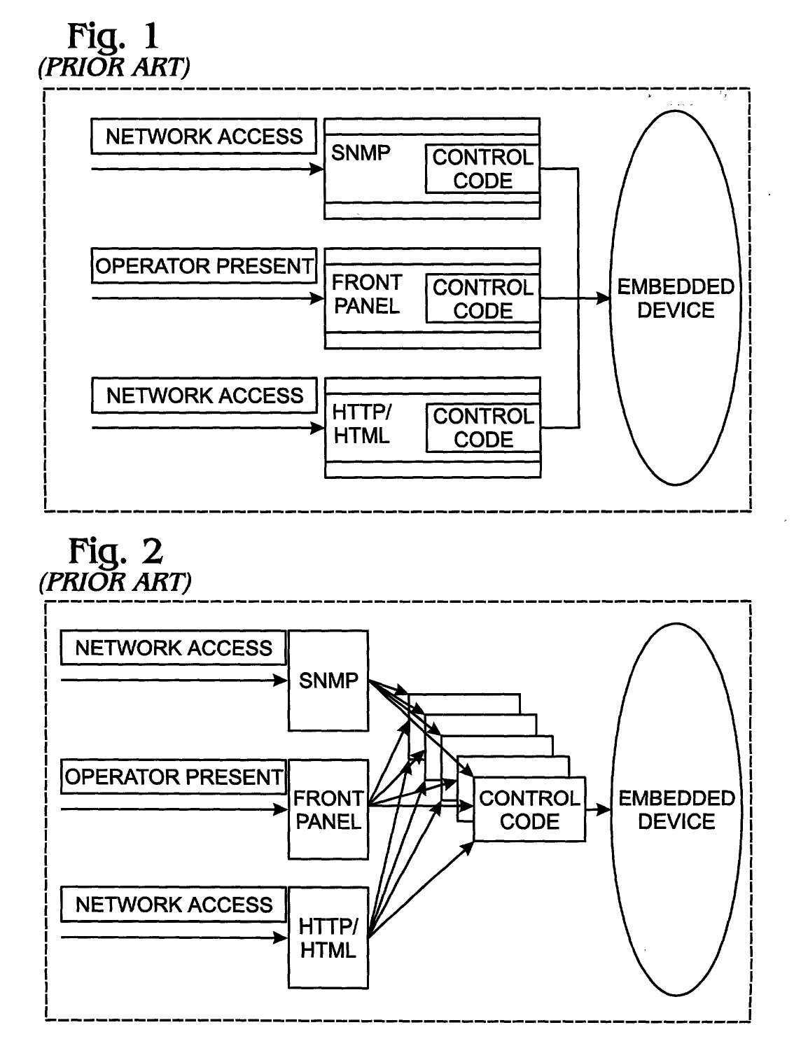

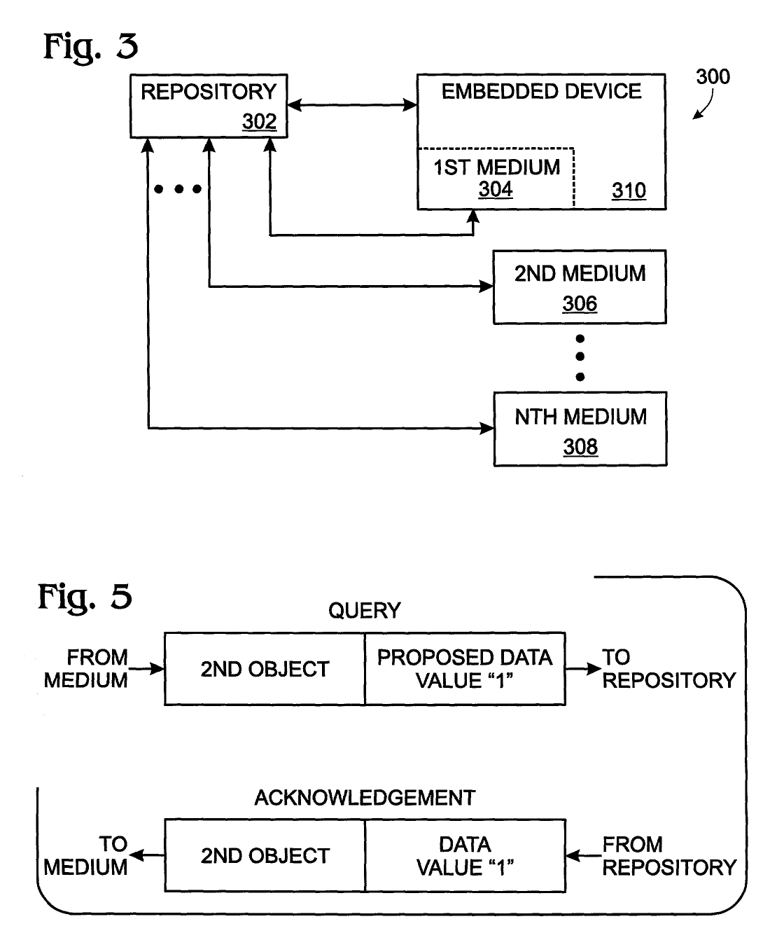

### DETAILED DESCRIPTION OF THE PREFERRED EMBODIMENTS

Some portions of the detailed descriptions that follow are presented in terms of procedures, steps, logic blocks, codes, processing, and other symbolic representations of operations on data bits within a computer memory or processor. These descriptions and representations are the means used by those skilled in the data processing arts to most effectively convey the substance of their work to others skilled in the art. A procedure, computer executed step, application, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like. These physical devices can be considered to interact with logical processes or applications and, therefore, are “connected” to logical operations. For example, a memory can store or access code to further a logical operation, or an application can call a code section from memory for execution.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “connecting” or “accessing” or “calling” or “translating” or “displaying” or “prompting” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

FIG. 3 is a schematic block diagram illustrating the present invention system for controlling an embedded device. The system 300 comprises a control code repository 302 and a first plurality of mediums accessing the repository 302. Shown are a first medium 304, a second medium 306, and an nth medium 308. Although only three mediums are shown, the present invention is not limited to any particular number of mediums. The system further comprises an embedded device 310 responsive to control code communications from the repository 302.

The first plurality of mediums are selected from the group including an embedded device front panel, simple network management protocol (SNMP), hypertext transport protocol (HTTP), a serial port, and a parallel port. It should be understood that multiple instances of the same medium type can be connected to the repository 302, and that not all types of mediums need to be connected. As an example, it will be assumed that the first medium 304 is a front panel, the second medium 306 is a SNMP interface, and the nth medium 308 is an HTTP interface. For the purpose of the example, it will be assumed that the embedded device in an MFP.

The repository 302 includes a second plurality of control routines, and the embedded device 310 includes a second plurality of embedded device functions controlled through the second plurality of control routines. For example, some MFP device functions that can be controlled are: setting a default input (paper) tray; disabling IP network stack; setting duplex printing mode (both sides of paper); and, setting an alternate (different) output tray.

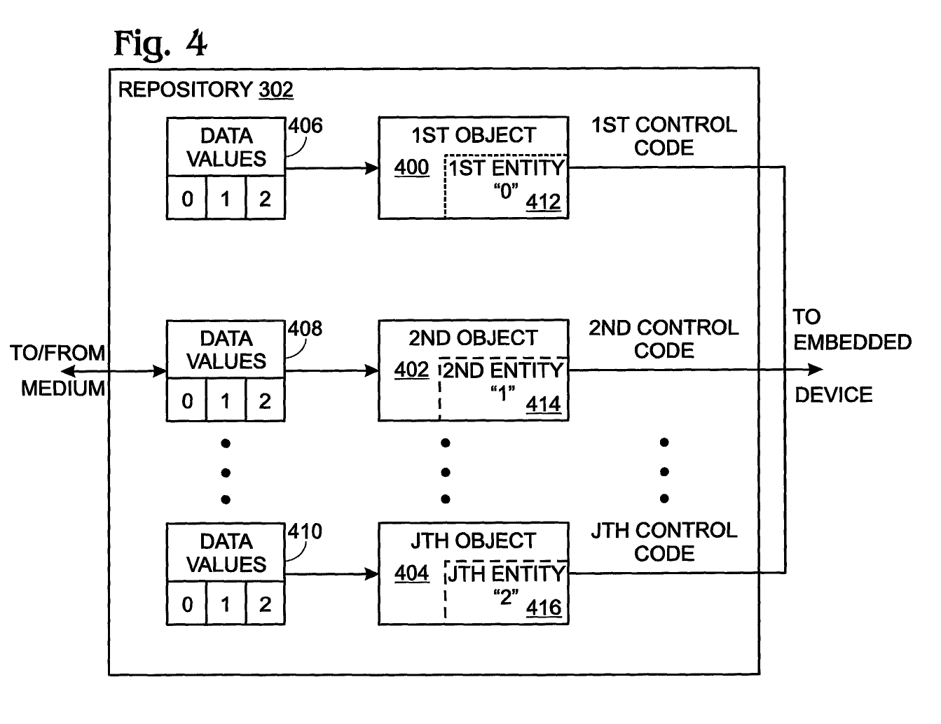

FIG. 4 is a schematic block diagram illustrating the repository 302 of FIG. 3 in greater detail. The repository 302 further comprises a second plurality of objects corresponding to the second plurality of control routines. Shown are a first object 400, a second object 402, and a jth object 404. However, the present invention is not limited to any particular number of objects. The repository also includes a second plurality of data selectors with a range of selectable data values corresponding to object. Shown are data selectors 406, 408, and 410 corresponding to objects 400, 402, and 404, respectively. Each data selector is shown offering the data values of “0”, “1”, and “2”. However, the present invention is not limited to any particular data values or range of values. Further, the data values and ranges may be different for each data selector. The repository 302 selects data values, and issues commands to the embedded device in response to the data values.

FIG. 5 is an exemplary communication pattern such as might occur between the repository 302 and a medium. More specifically, a medium from the first plurality of mediums queries the repository, the first medium 304 for example (see FIG. 3). The first medium identifies an object as the subject of the query. For example, the first medium identifies the second object as the subject. Then, the first medium receives an acknowledgement from the repository 302, in response to the query. The acknowledgement identifies an object as the subject of the response. In this example the second object is identified. The acknowledgment also includes a data value associated with the identified object. For the purpose of this example, a data value of “1” is used.

With respect to the query, the medium proposes the data value associated with the identified object. For example, the first medium proposes a data value of “1”. The medium then receives an acknowledgement from the repository acknowledging the use of the proposed data value.

Referring again to FIG. 4, the repository 302 establishes a data entity, which can be thought of as a file, associated with each object. Shown are first data entity 412, second data entity 414, and jth data entity 416. Continuing the example, the second data entity 414 contains the data value “1”. The repository 302 receives the data values proposed by the mediums, and writes the proposed data values in the corresponding object data entities.

In some aspects of the invention, the repository 302 establishes an asynchronous notification associated with an object, the first object 400 for example. The repository 302 also establishes a notification trigger associated with the object's data entity. In response to the occurrence of the notification trigger, the occurrence of any data value in the first data entity 412, the repository sends the notification to the first plurality of mediums. The mediums identify the object as the subject of the notification and receive the data value associated with the subject object in the notification. In this example the notification includes the subject first object 400 and the data value of “0”. In this manner, the mediums are able to identify to occurrence of specific events associated with either the medium or the embedded device.

The repository establishes a repository calling interface for communications with the repository. The calling interface includes object and data value fields for communications with a corresponding data entity. For example, a first object and first data value are fields that would be used to write to the first data entity. FIG. 5 is merely intended to illustrate the type of information that can be communicated between the mediums and not the format. The present invention is not limited to any particular calling interface or communication protocol, either between the repository and the mediums, or between the repository and the embedded device. Each of the first plurality of mediums communicates using a corresponding communication protocol. For example, the second (SNMP) medium 306 uses a SNMP communication protocol and the nth (HTTP) medium 308 uses HTTP protocol. However, each medium converts its corresponding communication protocol into appropriate object and data value fields for communications with a corresponding data entity in the repository, and calls the repository interface for communications with the repository 302.

The present invention makes the control code part of the data repository. This yields only one interface to call in order to set data in the repository which, in turn, causes the control code to modify the embedded device. The invention is different from a conventional system in removing the control code from the embedded device and placing it in a data repository. Control of the embedded device data is driven by placing all of the control variables (data entities) into the repository. Since the repository is accessed through a common interface, i.e. an application interface (API), the embedded device can be controlled from any medium by simply calling the API. Since the control code is centralized, and does not have to be repeated, the overall size of the code is reduced.

Additionally, the control is no longer tied to a particular medium. For example, if the IP protocol stack is disabled from SNMP, and SNMP cannot be accessed any more to activate the IP stack, the IP stack can be enabled from the front panel by the same control code that SNMP would call in order to enable the IP stack. The centralized control code permits multiple paths to be utilized in controlling the embedded device.

The following example demonstrates how SNMP prtChannelState is implemented into a VIO Status repository. Through the prtChannelState, SNMP can disable data paths through which a printer can receive print jobs. One such path is the IP network stack. Another path is the parallel port.

The developer implements this example in two stages as follows:

1). The developer adds prtchannelState to the data repository for every possible channel on the embedded device. If there were four channels, there are four prtOhannelState variables, one for each channel.

2). The developer writes several “write call back routines’ and associate each one with each prtChannelState data entity. For example, a network stack requires a different disabling/enabling process than a parallel port. Therefore, a different “write call back routine” is required. The “write call back routines” activate or deactivate the print channels in the MFP depending upon the new value of each prtChannelState data entity. At this point, any piece of code that sets any of the prtOhannelState parameters to a disable value triggers the “write call back routine” to do a specific channel disable for that parameter. The opposite is also true if the enable value is written to any of the prtChannelState parameters.

The example is not designed to be a definitive example of adding control for the SNMP prtchannelstate parameter into a VlO Status repository. Rather, it is designed only to demonstrate one way that an implementation could be done with the VIO Status repository. The repository concept is too flexible to delineate every possible way of implementing this SNMP table member. Rather, a prtChannelState parameter for each channel is created in the repository, since this table is static. The present invention removes the control code from the control mechanism to a centralized data repository. As a result, a single subroutine interface accesses the repository in order change data entity in the repository, which in turn, activates the control code to modify the system. Particulars of the implementation of the above-mentioned steps can be found in the “VIO Status Developer's Guide”, which is incorporated herein by reference.

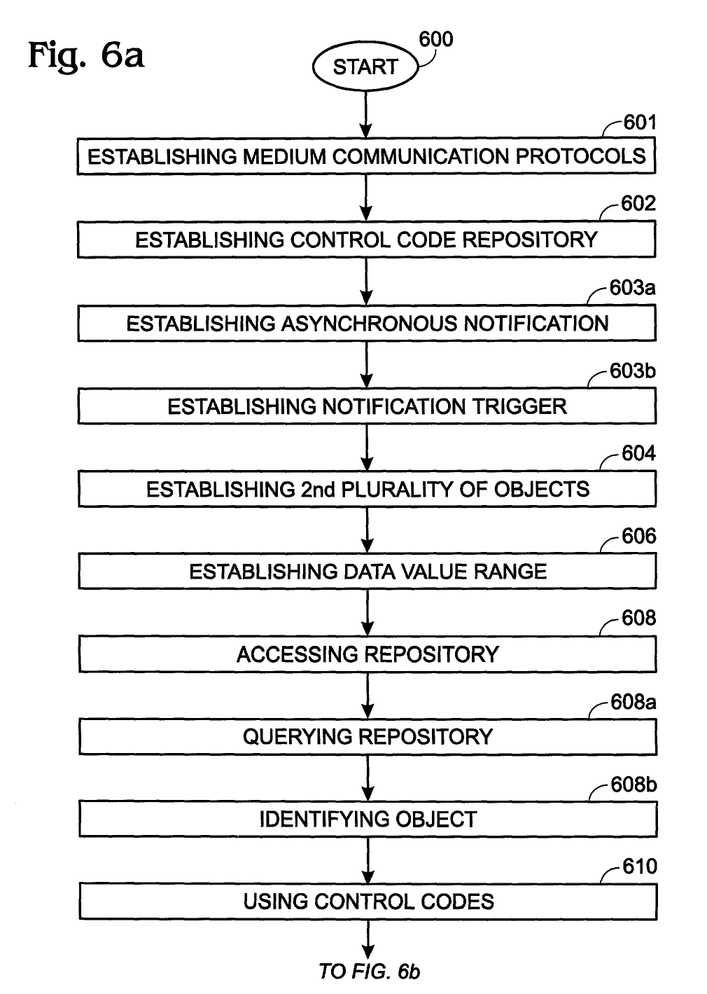

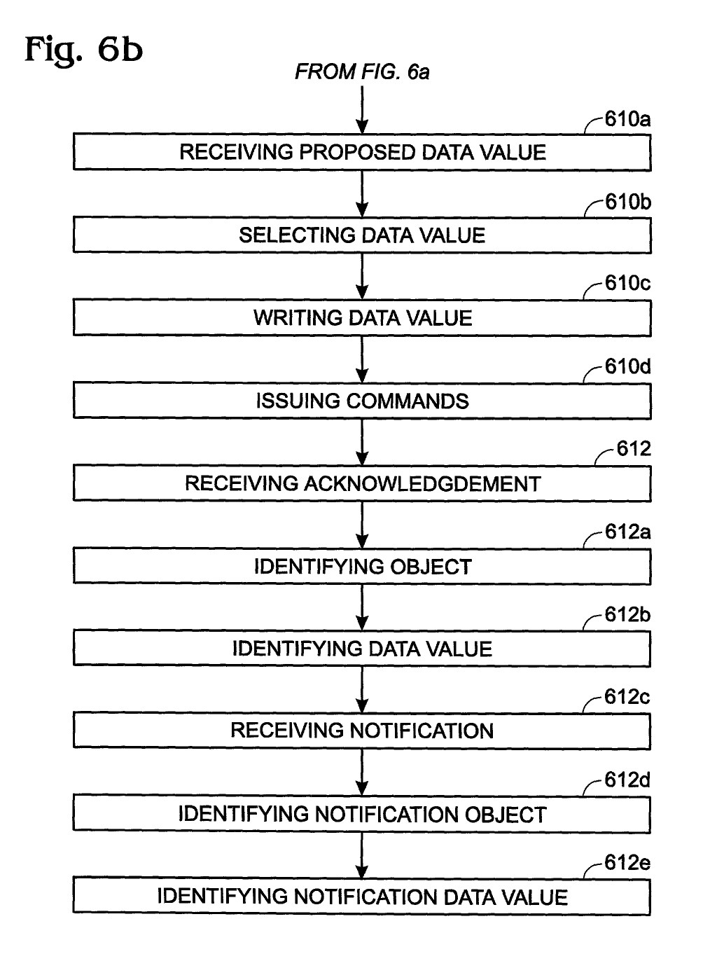

FIGS. 6a and 6b are flowcharts illustrating the present invention method for controlling an embedded device. Although the method is depicted as a sequence of numbered steps for clarity, no order should be inferred from the numbering unless explicitly stated. The method begins at Step 600. Step 602 establishes a control code repository. Step 604 establishes a second plurality of objects corresponding to the second plurality of control routines. Step 606 establishes a range of selectable data values associated with each object. Step 608 accesses the repository through a first plurality of mediums. Step 610 uses the control codes to communicate with an embedded device.

Accessing the repository through a first plurality of mediums in Step 608 comprises accessing the repository through mediums selected from the group including an embedded device front panel, simple network management protocol (SNMP), hypertext transport protocol (HTTP), a serial port, and a parallel port.

In some aspects of the invention, establishing a control code repository in Step 602 includes establishing a second plurality of control routines. Then, using the control codes to communicate with an embedded device in Step 610 includes controlling a second plurality of embedded device functions through the second plurality of control routines.

In other aspects of the invention, establishing a control code repository in Step 602 includes establishing a data entity associated with each object. Then, using the control codes to communicate with an embedded device in Step 610 includes substeps. Step 610a receives the data values proposed by the mediums. Step 610b selects data values. Step 610c writes the proposed data values in the corresponding object data entities. Step 610d issues commands to the embedded device in response to the data values.

In some aspects of the invention, accessing the repository through a first plurality of mediums in Step 608 includes substeps. Step 608a queries the repository from a medium. Step 608b identifies an object as the subject of the query. Then, the method comprises a further step. Step 612 receives an acknowledgement in response to the query. Receiving an acknowledgement in response to the query includes substeps. Step 612a identifies an object as the subject of the response, and Step 612b identifies a data value associated with the identified object.

In some aspects of the invention, accessing the repository through a first plurality of mediums in Step 608 includes proposing the data value associated with the identified object. Then, receiving an acknowledgement in response to the query in Step 612 includes acknowledging the use of the proposed data value.

Some aspects of the invention include further steps. Step 603a, at the repository, establishes an asynchronous notification associated with a third object. Step 603b establishes a notification trigger associated with third object data entity. In Step 612c the first plurality of mediums receive the notification in response to the occurrence of the notification trigger. Step 612d identifies the third object as the subject of the notification. Step 612e receives a third data value associated with the third object in the notification.

In some aspects of the invention a further step, Step 601 establishes a first plurality of communication protocols corresponding to the first plurality of mediums. Establishing a control code repository in Step 602 includes establishing a repository calling interface including object and data value fields for communications with corresponding data entities in the repository. Then, accessing the repository through a first plurality of mediums in Step 608 includes each medium converting its corresponding communication protocol into appropriate object and data value fields for communications with corresponding data entities, and calling the repository interface.

A system and method of controlling an embedded device through a centralized control code repository have been provided. A few examples have been provided to illustrate the invention using an MFP as an exemplary embedded device. However, the invention has broader implications and uses beyond the examples. Other variations and embodiments of the invention will occur to those skilled in the art.

We claim:

1. A method for controlling an embedded device, the method comprising:
establishing a control code repository;
accessing the repository through a first plurality of mediums; and,
using the control codes to communicate with an embedded device.

2. The method of claim 1 wherein accessing the repository through a first plurality of mediums comprises accessing the repository through mediums selected from the group including an embedded device front panel, simple network management protocol (SNMP), hypertext transport protocol (HTTP), a serial port, and a parallel port.

3. The method of claim 2 wherein establishing a control code repository includes establishing a second plurality of control routines; and,
wherein using the control codes to communicate with an embedded device includes controlling a second plurality of embedded device functions through the second plurality of control routines.

4. The method of claim 3 further comprising:
establishing a second plurality of objects corresponding to the second plurality of control routines;
establishing a range of selectable data values associated with each object;
wherein using the control codes to communicate with an embedded device includes:
selecting data values; and,
issuing commands to the embedded device in response to the data values.

5. The method of claim 4 wherein accessing the repository through a first plurality of mediums includes:
querying the repository from a medium;
identifying an object as the subject of the query; and,
the method further comprising:
receiving an acknowledgement in response to the query.

6. The method of claim 5 wherein receiving an acknowledgement in response to the query includes:
identifying an object as the subject of the response; and,
identifying a data value associated with the identified object.

7. The method of claim 6 wherein accessing the repository through a first plurality of mediums includes proposing the data value associated with the identified object; and,
wherein receiving an acknowledgement in response to the query includes acknowledging the use of the proposed data value.

8. The method of claim 7 wherein establishing a control code repository includes establishing a data entity associated with each object;
wherein using the control codes to communicate with an embedded device includes:
receiving the data values proposed by the mediums; and,
writing the proposed data values in the corresponding object data entities.

9. The method of claim 8 further comprising:
at the repository, establishing an asynchronous notification associated with a third object;
establishing a notification trigger associated with third object data entity;
in response to the occurrence of the notification trigger, receiving the notification at the first plurality of mediums;
identifying the third object as the subject of the notification; and,
receiving a third data value associated with the third object in the notification.

10. The method of claim 8 further comprising:
establishing a first plurality of communication protocols corresponding to the first plurality of mediums;
wherein establishing a control code repository includes establishing a repository calling interface with object and data value fields for communications with corresponding data entities in the repository; and,
wherein accessing the repository through a first plurality of mediums includes each medium converting its corresponding communication protocol into appropriate object and data values for communications with corresponding data entities, and calling the repository interface.

11. A method for controlling an embedded device, the method comprising:
establishing a control code repository;
establishing a second plurality of objects corresponding to a second plurality of control routines;
establishing a range of selectable data values associated with each data object;
accessing the repository through a first plurality of mediums selected from the group including an embedded device front panel, simple network management protocol (SNMP), hypertext transport protocol (HTTP), a serial port, and a parallel port; and,
using the control codes to communicate with an embedded device as follows:
selecting data values; and,
issuing commands to the embedded device in response to the data values.

12. A system for controlling an embedded device, system comprising:
a control code repository;
a first plurality of mediums accessing the repository; and,
an embedded device responsive to control code communications from the repository.

13. The system of claim 12 wherein the first plurality of mediums are selected from the group including an embedded device front panel, simple network management protocol (SNMP), hypertext transport protocol (HTTP), a serial port, and a parallel port.

14. The system of claim 13 wherein the repository includes a second plurality of control routines; and,
wherein the embedded device includes a second plurality of embedded device functions controlled through the second plurality of control routines.

15. The system of claim 14 wherein the repository further comprises:
a second plurality of objects corresponding to the second plurality of control routines;
a second plurality of data selectors with selectable data values, corresponding to each object; and,
wherein the repository selects data values, and issues commands to the embedded device in response to the data values.

16. The system of claim 15 wherein a medium from the first plurality of mediums queries the repository, identifies an object as the subject of the query, and receives an acknowledgement from the repository, in response to the query.

17. The system of claim 16 wherein the medium receives an acknowledgement from the repository identifying an object as the subject of the response and including a data value associated with the identified object.

18. The system of claim 17 wherein the medium proposes the data value associated with the identified object and receives an acknowledgement from the repository acknowledging the use of the proposed data value.

19. The system of claim 18 wherein the repository establishes a data entity associated with each object, receives the data values proposed by the mediums, and writes the proposed data values in the corresponding object data entities.

20. The system of claim 17 wherein the repository establishes an asynchronous notification associated with a third object, establishes a notification trigger associated with a third object data entity, and in response to the occurrence of the notification trigger, sends the notification to the first plurality of mediums; and,
wherein the mediums identify the third object as the subject of the notification and receive a third data value associated with the third object in the notification.

21. The system of claim 17 wherein the repository establishes a repository calling interface including object and data value fields for communications with corresponding data entities in the repository; and,
wherein each of the first plurality of mediums communicates using a corresponding communication protocol, wherein each medium converts its corresponding communication protocol into appropriate object and data value fields for communications with corresponding data entities, and calls the repository interface.
